(19) United States
(12) Patent Application Publication
(10) Pub. No.: US 2026/0233685 A1
(43) Pub. Date: Aug. 13, 2026

(54) DEVICE HOLDER SYSTEM FOR A VEHICLE AND VEHICLE SEAT

(71) Applicant: Ford Global Technologies, LLC, Dearborn, MI (US)

(72) Inventors: Chris Fredriksson, LaSalle (CA); Ranjit Nagi, Saline, MI (US)

(73) Assignee: Ford Global Technologies, LLC, Dearborn, MI (US)

(21) Appl. No.: 19/052,414

(22) Filed: Feb. 13, 2025

(51) Int. Cl. B60R 11/02; B60R 11/00

(52) U.S. Cl. CPC B60R 11/0252; B60R 2011/0015

(57) ABSTRACT

A device holder system for a vehicle includes a device holder mount configured to be supported on a support structure in a vehicle, the device holder mount having a mounting surface. One or more magnets are provided on the device holder mount proximate to the mounting surface. A removable insert is configured to connect onto the device holder mount and configured to secure a mobile device to the device holder mount. One or more slots are provided on one of the device holder mount and the removable insert, and one or more slides are provided on the other of the device holder mount and the removable insert. The one or more slots are configured to receive and support the one or more slides to retain the removable insert on the device holder mount.

### FIELD OF THE DISCLOSURE

The present disclosure generally relates to device holders for holding mobile devices onboard motor vehicles, and more particularly relates to a vehicle device holder system that accommodates different size mobile electronic devices.

Motor vehicles are commonly equipped with various entertainment and infotainment systems that typically include one or more media display screens. In addition, passengers frequently bring personal mobile electronic devices such as phones and tablets on board the motor vehicle. It may be desirable to provide for a device holder system for a vehicle that more readably accommodates the use of different mobile electronic devices.

According to a first aspect of the present disclosure, a device holder system for a vehicle includes a device holder mount configured to be supported on a support structure in a vehicle, the device holder mount having a mounting surface. One or more magnets are provided on the device holder mount proximate to the mounting surface. A removable insert is configured to connect onto the device holder mount and configured to secure a mobile device to the device holder mount. One or more slots are provided on one of the device holder mount and the removable insert, and one or more slides are provided on the other of the device holder mount and the removable insert. The one or more slots are configured to receive and support the one or more slides to connect the removable insert on the device holder mount.

Embodiments of the first aspect of the present disclosure can include any one or a combination of the following features:

an inductive charging device is provided on the device holder mount proximate to the mounting surface;

the inductive charging device comprises one or more inductive charging coils located within a charging pad and configured to inductively couple with one or more receiving coils in the mobile device;

the one or more magnets and the inductive charging device are integrated onto the charging pad;

the one or more slots comprises first and second slots and the one or more slides comprises first and second slides;

the first and second slots are located on the device holder mount, and the first and second slides are located on the removable insert;

the removable insert is selected from one of a plurality of removable inserts having different sizes for retaining different size mobile devices;

a plurality of retainer devices are located on the removable insert, wherein the plurality of retainer devices are configured to secure the mobile device;

the removable insert has a shape comprising four corners, and the plurality of retainer devices comprises four retainer straps located proximate the four corners; and

the device holder mount is configured to be installed on a rear side of a vehicle seat.

According to a second aspect of the present disclosure, a device holder system for a vehicle seat includes a device holder mount configured to be supported on the vehicle seat, the device holder mount having a mounting surface. One or more magnets are provided on the device holder mount proximate to the mounting surface. An inductive charging device is provided on the device holder mount proximate to the mounting surface. A removable insert is configured to connect onto the device holder mount and configured to secure a mobile device to the device holder mount. First and second slots are provided on one of the device holder mount and the removable insert, and first and second slides are provided on the other of the device holder mount and the removable insert. The first and second slots are configured to receive and support the one or more slides to connect the removable insert on the device holder mount.

Embodiments of the second aspect of the present disclosure can include any one or a combination of the following features:

the first and second slots are located on the device holder mount, and the first and second slides are located on the removable insert;

the removable insert is selected from one of a plurality of removable inserts having different sizes for retaining different size mobile devices;

a plurality of retainer devices are located on the removable insert, wherein the plurality of retainer devices are configured to support the mobile device;

the removable insert has a shape comprising four corners, and the plurality of retainer devices comprises four retainer straps located proximate the four corners; and

the device holder mount is configured to be installed on a rear side of a vehicle seat.

According to a second aspect of the present disclosure, a vehicle seat includes a seat base, a seat back having a rear side, and a device holder system. The device holder system includes a device holder mount supported on the seat back, the device holder mount having a mounting surface. One or more magnets are provided on the device holder mount proximate to the mounting surface. A removable insert is configured to connect onto the device holder mount and configured to secure a mobile device to the device holder mount. One or more slots are provided on one of the device holder mount and the removable insert, and one or more slides are provided on the other of the device holder mount and the removable insert. The one or more slots are configured to receive and support the one or more slides to connect the removable insert on the device holder mount.

Embodiments of the third aspect of the present disclosure can include any one or a combination of the following features:
an inductive charging device is provided on the device holder proximate to the mounting surface, wherein the inductive charging device comprises one or more inductive charging coils located within a charging pad;
the one or more slots comprises first and second slots and the one or more slides comprises first and second slides, and wherein the first and second slots are located on the device holder mount, and the first and second slides are located on the removable insert; and
one or more magnets and the inductive charging device are integrated onto the charging pad.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an elevated side perspective view of a portion of a passenger compartment of a motor vehicle having device holder systems supported on the rear side of each of two front row vehicle seats;

FIG. 2 is an enlarged rear perspective view of an upper portion of one of the front row seats with a mobile device supported on the device holder system;

FIG. 3 is a side view of the upper portion of the vehicle seat shown in FIG. 2 with the device holder system in different positions rotated about a horizontal axis;

FIG. 4 is a rear perspective view of the upper portion of the vehicle seat shown in FIG. 2 with the mobile device removed from the device holder system;

FIG. 5 is an elevated front perspective view of an upper portion of the seat further illustrating the device holder system;

FIG. 6 is a rear perspective view of an upper portion of the seat with a removable insert removed from the device holder system;

FIG. 7 is a rear view of the device holder system with the removable insert aligned to be assembled onto a device holder mount;

FIG. 8 is a lower front perspective view of the device holder system with the removable insert aligned with the device holder mount; and

FIG. 9 is a block diagram illustrating the inductive coupling and charging of a chargeable mobile device with the device holder system.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

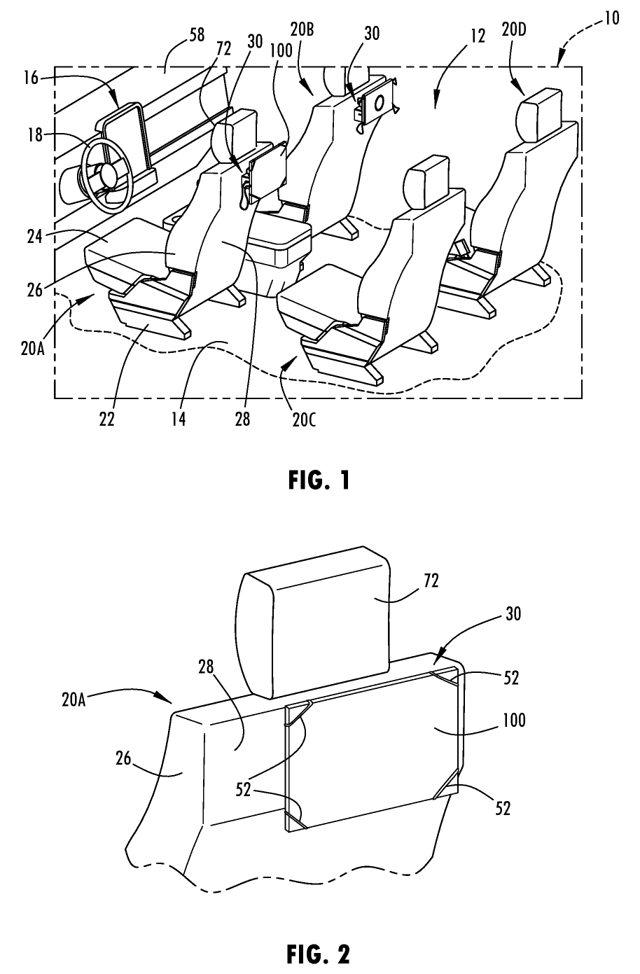

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a device holder system for a vehicle and a vehicle seat having a device holder system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

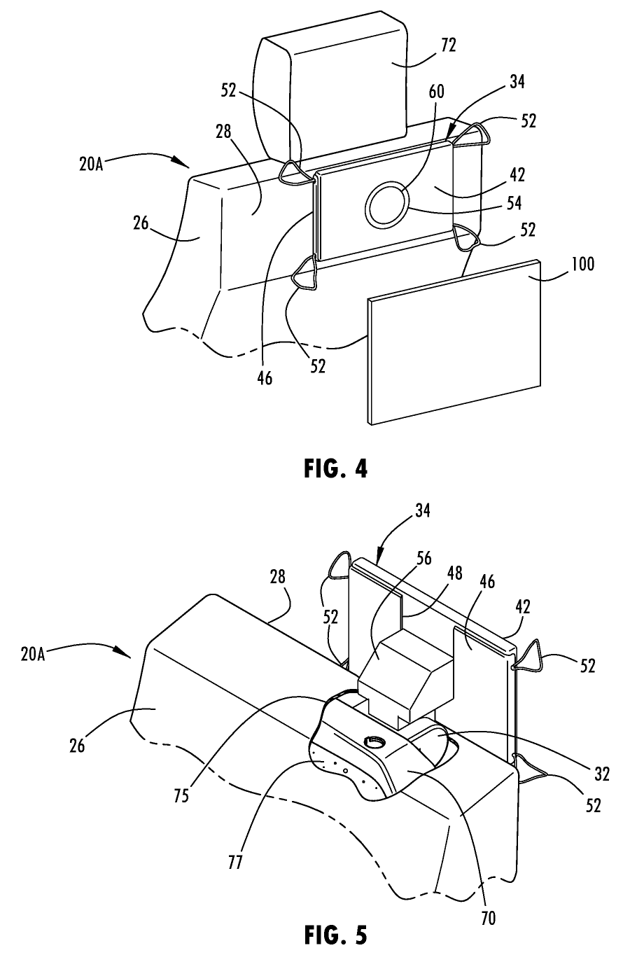

Referring to FIGS. 1-9, a device holder system 30 is generally illustrated for use on a motor vehicle 10. A pair of device holder systems 30 are shown located on the rear side of a pair of front row vehicle seats of the motor vehicle 10, according to one example. The device holder system 30 includes a device holder mount 34 configured to be supported on a support structure such as a seat back frame 70 on the rear side of vehicle seat 20A or 20B. The device holder mount 34 has a mounting surface 42. The device holder system 30 also includes one or more magnets 54 and an inductive charging device 60 provided on the device holder mount 34 proximate to the mounting surface 42. A removable insert 46 is configured to connect onto the device holder mount 34 and is configured to secure a mobile device 100 to the device holder mount 34. One or more slots 40A and 40B are provided on one of the device holder mount 34 and the removable insert 46, and one or more slides 50A and 50B are provided on the other of the device holder mount 34 and the removable insert 46, wherein the one or more slots 40A and 40B are configured to receive and support the one or more slides 50A and 50B to connect the removable insert 46 on the device holder mount 34. The removable insert 46 may be replaced with a different size removable insert to accommodate different size mobile devices.

With particular reference to FIG. 1, a passenger compartment 12 of a motor vehicle 10 is generally illustrated equipped with a pair of device holder systems 30, according to one embodiment. The motor vehicle 10 may be configured as a wheeled motor vehicle such as a sedan, a sport utility vehicle (SUV), a van, a truck, a bus, or other motorized vehicle configured to transport one or more passengers. The passenger compartment 12 is generally defined by a vehicle body and includes a floor 14. Supported on the floor 14 are a plurality of seats which include first and second front row seats 20A and 20B and third and fourth rear row seats 20C and 20D. The seating arrangement may include seats arranged in more than two rows. In the example shown, each of the front row seats 20A and 20B includes a seat frame 22 supported on top of the floor 14 and supporting a seat base 24 and a seat back 26. The seat back 26 in an upright seating position includes a back side 28 and a headrest 72 extending on the top side.

The front row seats 20A and 20B are shown arranged generally rearward of a dashboard 58 and a steering wheel 18. The first front row seat 20A is generally located directly rearward of the steering wheel 18, and thus serves as a driver’s seat for seating a driver of the motor vehicle 10. The motor vehicle 10 is also configured to include an infotainment touch screen display 16 generally located in a position viewable by the driver of the motor vehicle 10 seated in the first front row seat 20A and may also be viewable from other locations within the motor vehicle 10. The infotainment touch screen display 16 may display information generated by navigation and entertainment systems and other vehicle control systems made available on the motor vehicle 10.

In the example shown, both the first and second front row seats 20A and 20B are equipped with a device holder system 30 that is configured to hold a mobile device 100 and to provide electrical power to the mobile device 100 via inductive charging. The device holder system 30 is shown and described herein as fixedly mounted to the back side 28 of the seat back 26 according to one example. However, the device holder system 30 may otherwise be removably mounted to the seat back 26 via a coupling connected in other ways. The device holder system 30 advantageously is configured to include a removable insert that accommodates holding different size mobile devices, such as small and large mobile phones and tablets, for example.

The device holder system 30 is shown in FIG. 2 supporting a mobile device 100 on the back side 28 of the seat back 26 of the first front row seat 20A. The device holder system 30 is shown located on the upper back of the seat back 26 and below the headrest 72, in one example. As such, the mobile device 100 is presented in front of the rear row of seating to enable a rear seated passenger to view and use the mobile device 100 supported thereon. It should be appreciated that the device holder system 30 may be located elsewhere on the vehicle seat 20A such as a lower portion of the seat back 26 or on the headrest 72, according to other examples.

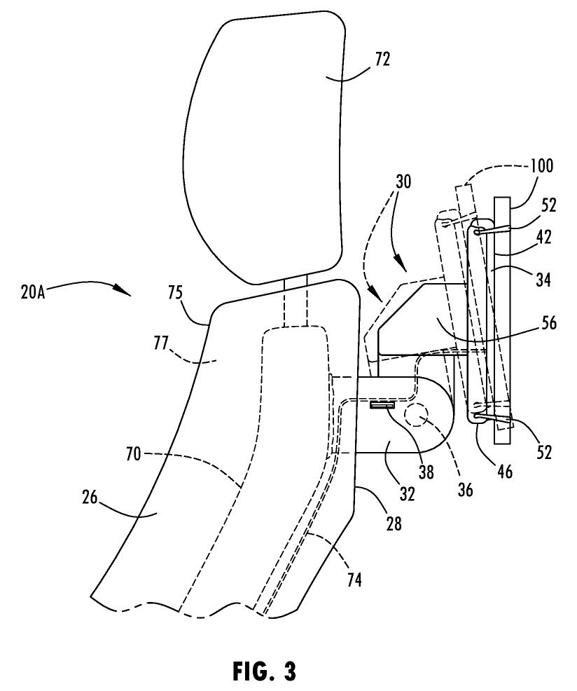

Referring to FIG. 3, the vehicle seat 20A is further illustrated supporting the device holder system 30. The vehicle seat 20A is shown having a seat back frame 70 generally extending vertically within the seat back 26. The seat back frame 70 is generally located within the seat back 26 and is covered with a cushion 77 such as a cushion made of foam and a seat cover 75 such as leather, vinyl or cloth, for example, such that the seat back frame 70 and cushion 77 is generally covered. In addition, the seat back 26 has a cable 74 generally extending through at least a portion of the seat back 26 which may include electrical power and communication lines such as wires to supply electrical power from a vehicle battery source and may further provide data communication. The cable 74 may supply electrical power to an inductive charger and also electrical power and data communication via a communication port such as a USB port 38 located on a lateral side of the device holder system 30.

The device holder system 30 includes a bracket 32 which is shown supported by the back side 28 of the seat back frame 70, according to one example. The bracket 32 may be fixedly supported by the seat back frame 70 such as via fasteners or welding, or may be integrally formed, e.g., molded, with the seat back frame 70. The bracket 32 generally extends rearward of the seat back 26 within an opening of the seat cover 75 such that at least the rear end of the bracket 32 is exposed on the rear side of the seat back 26. The device holder system 30 has a device holder mount 34 supported by the bracket 32 via a support arm 56. The device holder mount 34, bracket 32 and support arm 56 may be one piece or separate pieces. The support arm 56 is pivotally connected about a horizontal pivot axle 36 on bracket 32. As such, the device holder mount 34 may pivot about a horizontal axis so as to tilt at different angles. The device holder mount 34 has a mounting surface 42 on the rear side configured to allow the mobile device 100 to be mounted on or proximate thereto.

As seen in FIGS. 3-5, the device holder system 30 includes a removable insert 46 configured to connect onto the device holder mount 34 and to secure the mobile device 100 to the device holder mount 34. The removable insert 46 removably couples to the device holder mount 34 and includes a plurality of retaining devices shown in the form of retainer straps 52 that are configured to secure onto a mobile device. The removable insert 46 in the embodiment generally has a shape that includes four corners. For example, the removable insert 46 may have a generally rectangular shape including the four corners. The plurality of retaining devices may comprise four retainer straps 52 located proximate to the four corners of the removable insert 46. The removable insert 46 is configured having a size appropriate to hold a mobile device having a similar size. The removable insert 46 may be removed and replaced with one or more different size removable inserts that are shaped and sized to accommodate the securement of different size mobile devices. As such, a user may remove one size removable insert 46 and replace it with another size removable insert 46 to accommodate different size mobile devices.

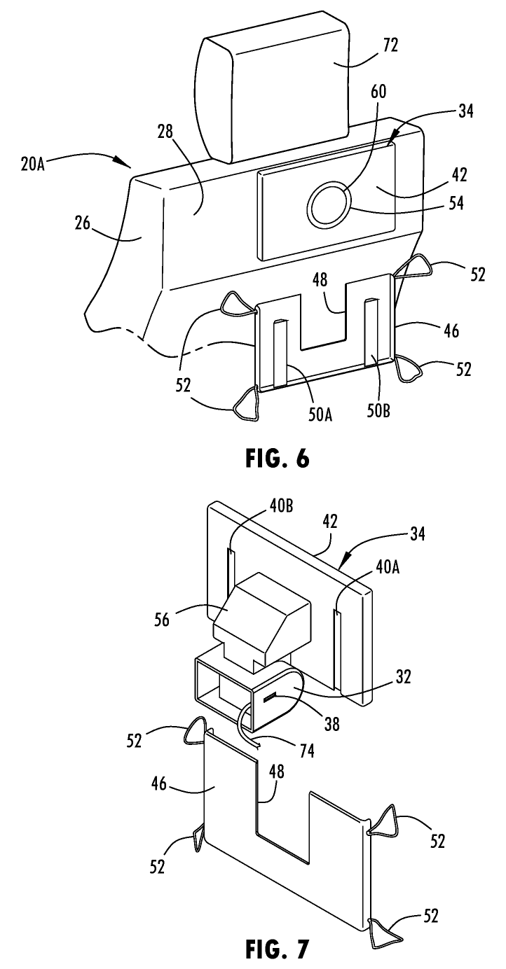

Referring to FIGS. 6-8, the device holder system 30 is illustrated having connectors for connecting the removable insert 46 onto the device holder mount 34. The connectors include one or more slots 40A and 40B provided on the device holder mount 34 and the removable insert 46 and one or more slides 50A and 50B provided on the other of the device holder mount 34 and the removable insert 46, wherein the one or more slots 40A and 40B are configured to receive and support the one or more slides 50A and 50B to connect and secure the removable insert 46 on the device holder mount 34. In the example shown, first and second slots 40A and 40B are formed on the rear side of the device holder mount 34 and generally extend vertically from a bottom edge upward to a terminal end. The first and second slots 40A and 40B are generally spaced on opposite sides of the support arm 56. First and second slides 50A and 50B are provided on the removable insert 46 in this example. The first and second slides 50A and 50B generally extend from a bottom edge of the removable insert 46 upward to a terminal end and are configured with a shape and size sufficient to be engaged within the corresponding first and second slots 40A and 40B and retained therein. As such, the first and second slides 50A and 50B engage within and are retained by the first and second slots 40A and 40B via friction, for example, to hold the removable insert 46 in the assembled use position. It should be appreciated that the first and second slides 50A and 50B may engage one or more retention members to securely retain the first and second slides 50A and 50B within first and second slots 40A and 40B, respectively. The removable insert 46 at least partly extends in the front side of the device holder mount 34 and has a U-shaped cutout that receives support arm 56.

The device holder mount 34 is configured to include an inductive charging device 60 that is provided proximate to the mounting surface 42. The inductive charging device 60 includes inductive charging circuitry and one or more magnets 54 that extend around the perimeter thereof and is configured and used to align and magnetically attach to a chargeable mobile electronic device having inductive charging circuitry and one or more magnets 54 or ferromagnetic material. In the example shown, a disc shaped charging pad is shown including the inductive charging device 60 and the one or more magnets 54 and is configured to be aligned proximate to the inductive charging circuitry in the mobile chargeable electronic device 100 that is coupled thereto by aligning the one or more magnets 54. However, it should be appreciated that the disc-shaped charging pad configured may otherwise be configured, according to other examples.

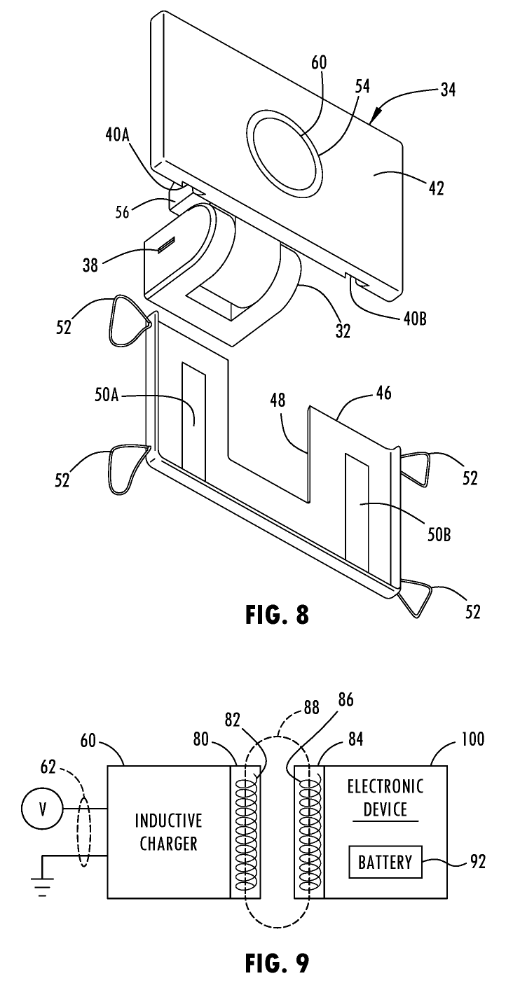

It should be appreciated that the removable insert 46 may be assembled onto the device holder mount 34 as shown in FIG. 8 by aligning the first and second slides 50A and 50B and inserting them into the first and second slots 40A and 50B until the removable insert 46 is fully assembled onto and retained by the device holder mount 34. A mobile device 100, such as a phone or tablet, may then be assembled onto the mounting surface 42 of the device holder mount 34 by connecting the four retainer straps 52 over the four corners of the mobile device 100. It should be appreciated that the one or more magnets 54 may help to retain the mobile device 100 on the mounting surface 42 of the device holder mount 34 for purposes of holding the mobile device 100 and providing proper alignment of the inductive charging device 60 on the device holder mount 34 with the inductive circuitry in the mobile device 100. When a different size mobile device is intended to be used, the user may remove the removable insert 46 and replace it with a different size removable insert that accommodates the size and shape of the replacement mobile device 100.

Referring to FIG. 9, the inductive charging device 60 is shown having inductive charging circuitry 80 which may include inductive coils 82. The mobile chargeable electronic device 100 is also shown having inductive charging circuitry 84 which may likewise include inductive coils 86. When the mobile chargeable electronic device 100 is positioned sufficiently close to the inductive charging device 60 (e.g., within 10 cm), the inductive charging circuitry 80 in the inductive charger 60 may be inductively coupled to the inductive charging circuitry 84 in the mobile electronic device 100 to enable the inductive charging device 60 to charge one or more batteries 92 in the mobile electronic device 100. Typically, this may be achieved by coupling the inductive coils 82 of the inductive charging device 60 with the inductive coils 86 of the mobile electronic device 100 to create an inductive field 88. The inductive charging device 60 receives power from a voltage supply V and is coupled to ground through the power cable 62. The power cable 62 may be electrically coupled to the vehicle battery and ground via circuitry such as a cable 74 or a plug-in connector 65, for example, a USB connector.

Accordingly, the device holder system 30 advantageously provides for a device holder and inductive charger for charging a mobile device 100 on a motor vehicle 10. The device holder system 30 advantageously may be assembled onto the rear side of a seat back of a vehicle seat to present a mobile device holder that is usable to one or more passengers seated rearward of the vehicle seat, such as rear row seated passengers. The device holder system 30 advantageously is reconfigurable with different size removable inserts to accommodate different size mobile devices.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A device holder system for a vehicle, the device holder system comprising:
a device holder mount configured to be supported on a support structure in a vehicle, the device holder mount having a mounting surface;
one or more magnets provided on the device holder mount proximate to the mounting surface;
a removable insert configured to connect onto the device holder mount and configured to secure a mobile device to the device holder mount;
one or more slots provided on one of the device holder mount and the removable insert; and
one or more slides provided on the other of the device holder mount and the removable insert, wherein the one or more slots are configured to receive and support the one or more slides to connect the removable insert on the device holder mount.

2. The device holder system of claim 1, further comprising an inductive charging device provided on the device holder mount proximate to the mounting surface.

3. The device holder system of claim 2, wherein the inductive charging device comprises one or more inductive charging coils located within a charging pad and configured to inductively couple with one or more receiving coils in the mobile device.

4. The device holder system of claim 3, wherein the one or more magnets and the inductive charging device are integrated onto the charging pad.

5. The device holder system of claim 1, wherein the one or more slots comprises first and second slots and the one or more slides comprises first and second slides.

6. The device holder system of claim 5, wherein the first and second slots are located on the device holder mount, and the first and second slides are located on the removable insert.

7. The device holder system of claim 1, wherein the removable insert is selected from one of a plurality of removable inserts having different sizes for retaining different size mobile devices.

8. The device holder system of claim 7, further comprising a plurality of retainer devices located on the removable insert, wherein the plurality of retainer devices are configured to secure the mobile device.

9. The device holder system of claim 8, wherein the removable insert has a shape comprising four corners, and the plurality of retainer devices comprises four retainer straps located proximate the four corners.

10. The device holder system of claim 1, wherein the device holder mount is configured to be installed on a rear side of a vehicle seat.

11. A device holder system for a vehicle seat, the device holder system comprising:
a device holder mount configured to be supported on the vehicle seat, the device holder mount having a mounting surface;
one or more magnets provided on the device holder mount proximate to the mounting surface;
an inductive charging device provided on the device holder mount proximate to the mounting surface;
a removable insert configured to connect onto the device holder mount and configured to secure a mobile device to the device mobile mount;
first and second slots provided on one of the device holder mount and the removable insert; and
first and second slides provided on the other of the device holder mount and the removable insert, wherein the first and second slots are configured to receive and support the one or more slides to connect the removable insert on the device holder mount.

12. The device holder system of claim 11, wherein the first and second slots are located on the device holder mount, and the first and second slides are located on the removable insert.

13. The device holder system of claim 11, wherein the removable insert is selected from one of a plurality of removable inserts having different sizes for retaining different size mobile devices.

14. The device holder system of claim 11, further comprising a plurality of retainer devices located on the removable insert, wherein the plurality of retainer devices are configured to support the mobile device.

15. The device holder system of claim 14, wherein the removable insert has a shape comprising four corners, and the plurality of retainer devices comprises four retainer straps located proximate the four corners.

16. The device holder system of claim 11, wherein the device holder mount is configured to be installed on a rear side of a vehicle seat.

17. A vehicle seat comprising:
a seat base;
a seat back having a rear side; and
a device holder system comprising:
a device holder mount supported on the seat back, the device holder mount having a mounting surface;
one or more magnets provided on the device holder mount proximate to the mounting surface;
a removable insert configured to connect onto the device holder mount and configured to secure a mobile device to the device holder mount;
one or more slots provided on one of the device holder mount and the removable insert; and
one or more slides provided on the other of the device holder mount and the removable insert, wherein the one or more slots are configured to receive and support the one or more slides to connect the removable insert on the device holder mount.

18. The vehicle seat of claim 17, further comprising an inductive charging device provided on the device holder proximate to the mounting surface, wherein the inductive charging device comprises one or more inductive charging coils located within a charging pad.

19. The vehicle seat of claim 18, wherein the inductive charging device comprises one or more inductive charging coils located within a charging pad, wherein the one or more magnets and the inductive charging device are integrated onto the charging pad.

20. The vehicle seat of claim 17, wherein the one or more slots comprises first and second slots and the one or more slides comprises first and second slides, and wherein the first and second slots are located on the device holder mount, and the first and second slides are located on the removable insert.
